(19) United States
(12) Patent Application Publication
(10) Pub. No.: US 2005/0169126 A1
(43) Pub. Date: Aug. 4, 2005

(54) Library for storing and retrieving removable information storage elements

(76) Inventors: Duncan Wakelin, Bristol (GB); Rhys Wyn Evans, Wales (GB); Ian Peter Crighton, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/042,929

(22) Filed: Jan. 25, 2005

(30) Foreign Application Priority Data
Jan. 30, 2004 (GB) 0401984.0

(51) Int. Cl. G11B 7/085

(52) U.S. Cl. 369/30.38

(57) ABSTRACT

A tape library has a library controller that directs an accessor and a tape drive unit to perform the operations required for storage in a non-volatile memory of the tape cartridge of bar code label information that has been optically read from a tape cartridge bar code label. The non-volatile memory can be for example, a predefined storage location on the tape itself or the cartridge memory. One advantage is that bar code label information can be recovered in case the bar code label becomes unreadable or is lost.

### TECHNICAL FIELD

The present invention relates to the field of automated storage and retrieval systems, also known as libraries.

### CLAIM TO PRIORITY

This application claims priority to copending United Kingdom utility application entitled, “A LIBRARY FOR STORING AND RETRIEVING REMOVABLE INFORMATION STORAGE ELEMENTS,” having serial no. GB 0401984.0, filed Jan. 30, 2004, which is entirely incorporated herein by reference.

### BACKGROUND

In an automated information storage and retrieval system, also known as a library, numerous slots, or storage cells, are provided within the library. These storage cells are used to hold information media that are portable or removable from the library, such as magnetic tape cartridges or optical disks. The term “cartridge” used herein refers to any retaining structure for such removable information media. The storage cells typically have an opening in the front to allow the cartridge to be inserted or removed.

A library typically includes a controller, an accessor, a drive, and an Input/Output station. The library controller directs the actions of the other library components. The library controller can also connect to a host processor and respond to control commands from the host processor. The library controller inventories the storage cells noting the identity of each cartridge occupying a storage cell. If no cartridge is situated in a particular storage cell, the library controller records this storage cell as empty. Typically, each cartridge has a unique identifying mark, such as a bar code label, on an edge of the cartridge visible through the cell opening.

The accessor transports a selected cartridge between its origin and its destination. A storage cell, a drive, and the Input/Output station serve as origins and/or destinations. The accessor grips the cartridge with a holding device. The accessor may also be equipped with a vision system, such as a bar code reader, to read the label on a storage cell when the accessor is positioned near the storage cell.

During an inventory of the library, such as when the library is reset, the vision system scans the cells and reports to the library controller the identity of stored cartridges and their location within the array of storage cells. The library controller records the identity and location information in a database in order to create a library map. The library controller later refers to and updates this library map when a cartridge is moved between an origin and a destination. In this sense, the library controller must “know” the identity of each cartridge and its location within the array of cells in order to be able to retrieve the cartridge for access.

Libraries also have one or more drives to read data from a tape cartridge or write data to a tape cartridge. The accessor removes a selected tape cartridge from a storage cell and inserts it into the drive. Once in the drive, data can be read from the tape cartridge and sent to the host processor.

In some library configurations, the data is sent to the host processor through the library controller. Whereas, in other library configurations the data is transferred directly from the drive to the host processor. In this latter configuration, the library controller sends a response to the host processor indicating the selected cartridge is placed in the drive.

The host processor then issues a command to the drive to transfer the data. Likewise, data can be written from the host processor to the drive in either library configuration. In both configurations, the library controller directs the accessor to load the selected cartridge into the drive before the data is written to the cartridge.

Libraries also typically include an Input/Output station and an operator panel. The Input/Output station is a port through which a system operator can pass a cartridge to be added to the storage array or through which the accessor can pass a cartridge to the operator for removal from the storage array. The operator panel provides a communication mechanism for an operator to make requests to add cartridges to the library or remove cartridges from the library. The Input/Output station allows the operator to change cartridges in the storage array without requiring the library controller to inventory the entire storage array. Typically, an inventory must be taken each time a library access door is opened by the operator since it is not known whether the operator has added cartridges to the array, has removed cartridges from the library, or has not altered the contents of the library at all.

As stated before, an inventory of the library may require the vision system of the accessor to scan all the storage cells in the storage array and report to the library controller the identity of stored cartridges and their location within the array of storage cells. If a cartridge label cannot be detected or read when the accessor is near a storage cell, that cell is recorded as empty.

The vision system may also mistakenly classify a cell as being empty when, in fact, the cell is actually occupied. For example, a cartridge may occupy the cell but have an unreadable label, or even no label. A cartridge may be improperly oriented within the cell or a foreign object may occupy the cell. If the accessor attempts to insert a cartridge into such an occupied cell, an error condition will result causing a time consuming error recovery procedure to be initiated.

One known error procedure attempts to reduce such non-empty errors by directing the accessor's gripper to attempt to reach inside every cell which does not have an identifiable cartridge and verify by “touch” that the cell is actually empty. Any cell which is still not found to be empty is classified in the database as having an “occupied but invalid” status to prevent its use. An inventory of a 400 cell library, for example, can take three or four hours to complete using this procedure.

Examples for such libraries of the above described types are disclosed in U.S. Pat. Nos. 6,512,963; 5,581,522; 5,059,772; 6,216,057; 5,761,161.

### SUMMARY

The present invention provides for a library for storing and retrieving removable information storage elements. The removable information storage elements have non-volatile memory locations and optical information labels. The library has storage cells for storing the information storage elements. Further, the library has at least one drive for reading information from a removable information storage element.

An accessor of the library serves for transportation of removable storage elements between the storage cells and the drive or drives. An optical reader of the library is used for reading the optical information labels and a data transfer apparatus of the drive is used for transferring the data to the non-volatile memory location.

Further the library has a controller to direct the optical reader to read an optical information label and to direct the accessor to move the corresponding removable information storage element to the drive after the data has been read. Then the controller directs the data transfer apparatus to write the data to the non-volatile memory location.

The invention facilitates better protection of a library against lost or corruption of optical information labels of its removable information storage elements. If the optical information label of one of the removable information storage elements is lost or becomes unreadable this removable information storage element is moved from its storage cell to the drive for reading of the data from the non-volatile memory location. Thus, the data that would have been lost otherwise is recovered and normal operation of the library can proceed. This can substantially reduce the time delay that is caused by a loss of an optical information label.

In accordance with a preferred embodiment of the invention the library is a tape library for storing and retrieving tape cartridges. For example, the library implements the linear tape-open (LTO) technology. LTO technology is an ‘open format’ technology, which means that users can have multiple sources of media and compatible tape drives. The ULTRIUM format is the ‘high capacity’ implementation of LTO technology.

A LTO compliant cartridge has a non-volatile cartridge memory (LTO-CM) which is a memory chip embedded in the cartridge. It uses a radio frequency interface that eliminates the need for a physical power or signal connection between cartridge and tape drive. The LTO-CM is used for storing information which in other tape formats may be stored in the header at the beginning of the tape.

In accordance with a preferred embodiment of the invention the cartridge memory is used for storing the data that has been read from the optical information label. Alternatively or in addition the same data can be stored on a predefined storage location on the tape media itself.

### BRIEF DESCRIPTION OF THE DRAWINGS

In the following preferred embodiments of the invention will be described, by way of example only, and with reference to the drawings in which:

FIG. 1 is a schematic block diagram showing the tape library coupled to a host system,

FIG. 2 is a flow diagram illustrating the steps involved in storing the data in the non-volatile memory,

FIG. 3 is a flow diagram illustrating the steps involved in covering the data when the optical information label is lost or becomes unreadable.

### DETAILED DESCRIPTION

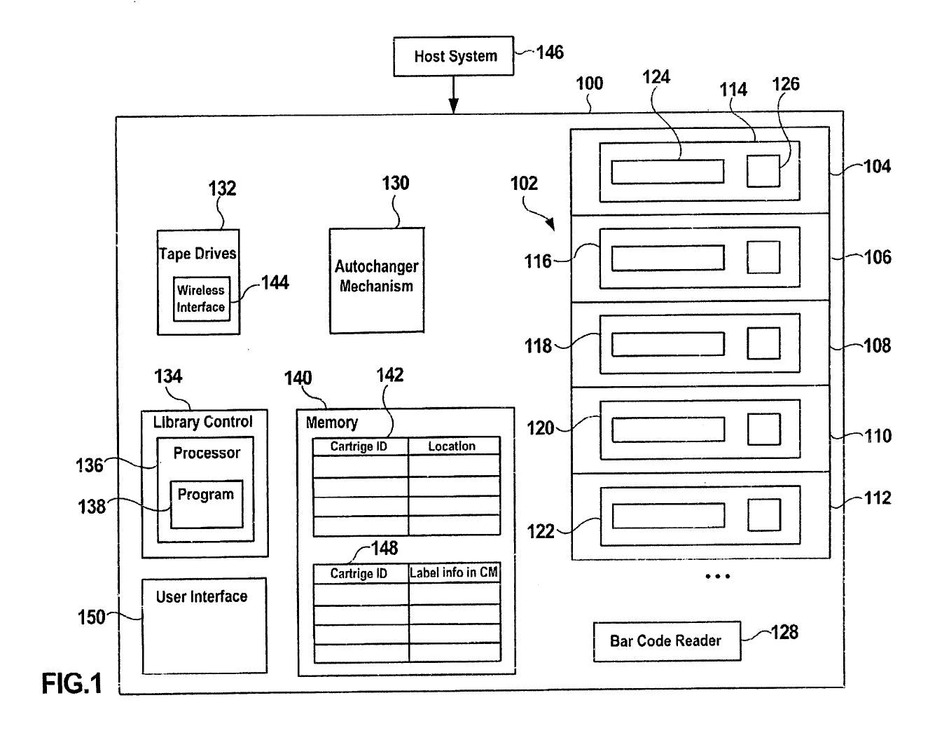

FIG. 1 shows tape library 100. Tape library 100 includes an array 102 of storage cells 104, 106, 108, 110, 112, . . . for holding respective magnetic tape cartridges 114, 116, 118, 120, 122, . . . Each one of the tape cartridges 114, 116, . . . has a bar code label 124 for storing of data, including a unique identifier for the respective tape cartridge to which the bar code label is attached. Such bar code labels 124 are commercially available from Hewlett Packard (cf. http://www.hpplm.com/newbarcodes.html).

Further each one of the tape cartridges 114, 116, . . . has a cartridge memory 126. Preferably tape library 100 uses LTO technology and ULTRIUM format tape cartridges. In this instance cartridge memories 126 are of the LTO-CM type.

Tape library 100 has bar code reader 128 for reading of the bar code labels 124 of the tape cartridges 114, 116, . . . when they are loaded in the array 102.

Accessor 130 implements an auto-changer mechanism for transportation of a selected one of the tape cartridges 114, 116, 118, 120, 122, . . . between array 102 and a tape drive unit 132. Tape drive unit 132 can have one or more tape drives.

The accessor 130 includes a gripper for holding the cartridge and the bar code reader 128 for reading bar code labels 124 for cartridge identification.

Tape library 100 contains a library controller 134 that uses a microprocessor 136 for running a computer program 138 to direct the operation of the accessor 130 and tape drive unit 132.

Further, tape library 100 has memory 140 that is coupled to library controller 134 for storing of various information, such as a cartridge map. The cartridge map maintains information on whether one or more of the storage cells 104, 106, . . . of array 102 are empty and regarding the loading of tape cartridges 114, 116 in the array 102. In particular memory 140 serves for storage of table 142 that maps tape cartridge identifiers (IDs) to storage cell locations of array 102.

Tape drive unit 132 has wireless interface 144 for reading and writing cartridge memory 126 of a tape cartridge loaded in tape drive unit 132.

Host system 146 is coupled to tape library 100 for storage of backup data or for recovering of previously backed up data.

In operation tape cartridges 114, 116, . . . are loaded into respective storage cells 104, 106, . . . . After completion of the loading of tape cartridges into storage cells computer program 138 is started in order to inventory tape library 100. Computer program 138 directs bar code reader 128 to scan all bar code labels 124.

Bar code reader 128 reports to the library controller 134 the information carried by the bar code labels 124 of the loaded tape cartridges and their respective locations within the array 102 of storage cells 104, 106, . . . . By means of the tape cartridge IDs contained in the bar code label information table 142 is generated and stored in memory 140 by computer program 138.

Further computer program 138 directs accessor 130 to move one of the tape cartridges 114, 116, . . . at a time to one of the tape drives of tape drive unit 132. Computer program 138 directs tape drive unit 132 to store at least the tape cartridge ID that has been read from the bar code label 124 of the respective tape cartridge on cartridge memory 126 of that tape cartridge by means of wireless interface 144. Next computer program 138 directs accessor 130 to move that tape cartridge back from tape drive unit 132 to its storage cell within array 102.

Preferably the storage of the bar code label information on the tape cartridge memories is tracked by computer program 138. For example computer program 138 generates an additional table 148 that indicates for which ones of the tape cartridges the storage operation of the bar code label information on the cartridge memory has been performed.

If array 102 is loaded with previously unused tape cartridges 114, 116, . . . computer program 138 directs accessor 130 and tape drive unit 132 to perform an inventory; this way the move and storage operation of respective bar code label information on the cartridge memories is performed for all of the tape cartridges.

However, an inventory of tape library 100 is not only performed when tape library 100 is used for the first time with new tape cartridges but also after tape library 100 has been opened and closed for manual insertion or removal of one or more tape cartridges by an operator. In this case computer program 138 directs bar code reader 128 to scan all the bar code labels 124 as cartridge locations of previously loaded tape cartridges may have been changed manually and/or one or more tape cartridges may have been inserted or removed from the storage cells of array 102.

By means of table 148 computer program 138 identifies those tape cartridges for which the storage operation of the bar code label information in the respective cartridge memories has already been performed. As a consequence computer program 138 directs accessor 130 and tape drive unit 132 to perform this storage operation of bar code label information onto cartridge memories only for new tape cartridges that are not identified in table 148. This has the advantage of substantially reducing the time required for an inventory of tape library 100.

If bar code reader 128 signals to computer program 138 that one of the bar code labels is unreadable or has been lost computer program 138 directs accessor 130 to move the tape cartridge from the storage cell location reported by bar code reader 128 to tape drive unit 132. Further computer program 138 directs tape drive unit 132 to read cartridge memory 126 by means of wireless interface 144. This way the bar code label information is recovered by computer program 138 and table 142 is completed on the basis of the recovered information. Further computer program 138 may output a message via user interface 150 in order to inform an operator that the bar code label of one of the tape cartridges in the storage cell that has been reported by bar code reader 128 has become unreadable or has been lost.

It is to be noted that the ability to recover bar code label information from the cartridge memory in case the bar code label has become unreadable or has been lost substantially reduces the delay that is otherwise experienced in such a situation. In prior art tape libraries it is necessary for the operator to manually intervene in case one of the bar code labels can not be read. This takes a substantial amount of time, especially since opening the tape library requires a new inventory operation. In contrast the present invention allows to avoid manual intervention and substantial delay as the only delay that is experienced due to a failure to read a bar code label is the move operation from the afflicted tape cartridge to the tape drive unit 132 and back to its storage cell.

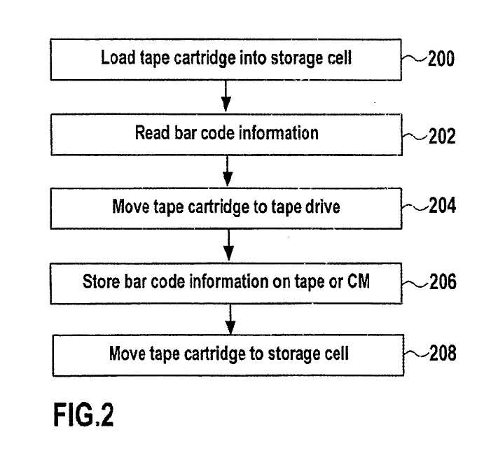

FIG. 2 shows a flow chart that illustrates the storage of bar code label information on the cartridge memory. In step 200 a previously unused tape cartridge is loaded into a storage cell of the array of the tape library. In step 202 the bar code information carried by the bar code label of the tape cartridge loaded in step 200 is read by the bar code reader.

On the basis of the bar code label information the tape cartridge is identified as being previously unused. In response the tape cartridge is moved to one of the tape drives in step 204. The bar code label information that has been read from the bar code label in step 202 is stored in the cartridge memory in step 206 by the tape drive. Alternatively the bar code label information can also be stored on a pre-defined storage location on the tape itself. After completion of the storage of the bar code label information the tape cartridge is moved back to its storage cell (step 208).

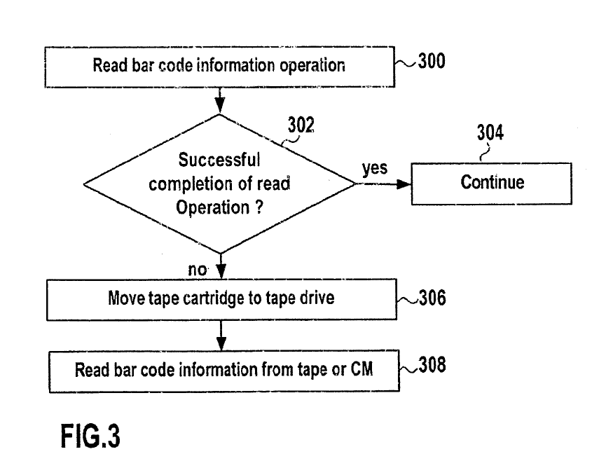

FIG. 3 shows a flow chart illustrating a recovery operation of bar code label information. In step 300 an attempt is made to read bar code label information. In case of successful completion of the read operation (step 302) normal operation continues (step 304), otherwise the tape cartridge is moved to one of the tape drives in step 306 in order to read the bar code label information from the cartridge memory or from the pre-defined storage location on the tape depending on the implementation (step 308).

Although the embodiments are described herein with respect to a magnetic tape library storing tape cartridges, the invention is not so limited but is equally applicable, for example, to an optical library holding optical disk cartridges, cartridge-less optical disks, optical tape cartridges, even magnetic disk cartridges or diskettes, and the like.

### LIST OF REFERENCE NUMERALS

100 Tape Library
102 Array
104 Storage Cell
106 Storage Cell
108 Storage Cell
110 Storage Cell
112 Storage Cell
114 Tape Cartridge
116 Tape Cartridge
118 Tape Cartridge
120 Tape Cartridge
122 Tape Cartridge
124 Bar Code Label
126 Cartridge Memory
128 Bar Code Reader
130 Accessor
132 Tape Drive Unit
134 Library Controller
136 Microprocessor
140 Computer Program
142 Table
144 Wireless Interface
146 Host System
148 Table
150 User Interface

1. A library for storing and retrieving removable information storage elements having a non-volatile memory location and an optical information label, the library comprising:
a plurality of storage cells for storing the information storage elements,
at least one drive for reading information from one of the removable information storage elements,
an accessor for transporting the removable information storage elements between the storage cells and the at least one drive,
an optical reader for reading data from the optical information labels,
a data transfer apparatus for transferring the data to the non-volatile memory location, and
a controller operable to direct the optical reader to read the data from the optical information label of one of the removable information storage elements loaded in one of the storage cells, to direct the accessor to move the one of the removable information storage elements to a selected said drive after the data has been read from the optical information label, and to direct the data transfer apparatus to write the data to the non-volatile memory location,
the controller being operable to direct the accessor to move the one of the removable information storage elements to the selected drive in response to a failed attempt to read the data from the optical information label, and to direct the data transfer apparatus to read the data from the non-volatile memory location.

2. The library of claim 1, the removable information storage elements being tape cartridges.

3. The library of claim 2, the non-volatile memory location being a pre-defined storage location on a tape of the tape cartridge.

4. The library of claim 2, the non-volatile memory location being provided by an electronic circuit attached to the tape cartridge.

5. The library of claim 4, the electronic circuit being a cartridge memory.

6. The library of claim 1, the optical reader being a bar code reader.

7. The library of claim 1, the data transfer apparatus having a wireless interface for transferring the data.

8. A method of protecting data stored on an optical information label of at least one of a plurality of removable information storage elements having a non-volatile memory location, the method comprising:
reading the data from the optical information label of one of the removable information storage elements loaded in a storage cell of a library,
moving the one of the removable information storage elements to a drive having a data transfer apparatus,
writing the data to the non-volatile memory location using the data transfer apparatus, and
moving the one of the removable information storage elements to the drive in response to a failed attempt to read the data from the optical information label, and to direct the data transfer apparatus to read the data from the non-volatile memory location.

9. The method of claim 8, wherein the removable information storage element is a tape cartridge.

10. The method of claim 9, wherein the non-volatile memory location is a predefined storage location of a tape of the tape cartridge.

11. The method of claim 9, wherein the non-volatile memory location is in an electronic circuit memory component attached to the tape cartridge.

12. The method of claim 9, wherein a wireless interface of the data transfer apparatus is used for writing the data.

13. The method of claim 9, the data comprising a unique identifier of the removable information storage element.

14. A method for recovery of data comprising:
reading the data from an optical information label of one of removable information storage elements loaded in a storage cell of a library, the one of the removable information storage elements having a non-volatile memory location, the library having a plurality of drives, each drive having a data transfer apparatus,
moving the one of the removable information storage elements to one of the drives,
writing the data to the non-volatile memory location of the one of the drives using the data transfer apparatus,
attempting to read the data from the optical information label of the removable information storage element after it has been reloaded in one of the storage cells of the library,
in response to failure of the attempt to read the data:
moving the removable information storage element from the storage cell to the same or another one of the drives, and
reading the data from the non-volatile memory location by the respective drive.

15. The method of claim 14, the removable information storage element being a tape cartridge.

16. The method of claim 15, wherein the data is read from a pre-defined storage location on a tape of the tape cartridge.

17. The method of claim 15, wherein the data is read from an electronic circuit memory component.

18. The method of claim 17, wherein the electronic circuit memory component is a cartridge memory.

19. A computer program product for performing the method of claim 15.

20. An apparatus for storing and retrieving removable information storage elements having a non-volatile memory location and an optical information label, comprising:
means for reading data from the optical information label,
means for moving at least one of the removable information storage elements to a removable information storage element drive means,
means for controlling the removable information storage element drive means to write the data to the non-volatile memory location, and
means for controlling the removable information storage element drive means to read the data from the non-volatile memory location in response to a failed attempt to read the data from the optical information label.
